(19) United States
(12) Patent Application Publication
(10) Pub. No.: US 2011/0180672 A1
(43) Pub. Date: Jul. 28, 2011

(54) Airplane with aerodynamic stall-prevention layout and pertinent longitudinal stability arrangement

(76) Inventors: Nandor Vestroci, Debrecen (HU); Fatemeh Hajibagher, Debrecen (HU)

(21) Appl. No.: 13/011,680

(22) Filed: Jan. 21, 2011

(30) Foreign Application Priority Data
Jan. 25, 2010 (HU) P1000048

(51) Int. Cl. B64C 3/16; B64C 5/02

(52) U.S. Cl. 244/35 R

(57) ABSTRACT

General purpose airplane with a swept back wing provided with a sharp leading edge as to cause flow separation and stall of the wing in cases where the limits of the regular flight envelope are exceeded in terms of angle of attack, and as a result to cause the front part of the airplane to move downward, said airplane also having positive lift-producing horizontal stabilizer provided with rounded leading edge, which does not stall at this point, therefore holds the tail in level during the process, all together acting to restore the original flight attitude. The horizontal stabilizer is essentially a straight (or similar) wing with a steeper lift-coefficient curve as that of the swept-back wing, therefore, in case of an un-commanded pitch-up of the airplane the greater increase of lift on the horizontal stabilizer together with its greater moment arm provides the stabilizing force to counter such pitching.

### BACKGROUND OF THE INVENTION

The invention aims to prevent aerodynamic stall in airplanes. Stall occurs in airplanes when the regular laminar airflow breaks down on the load-bearing surfaces of the different airfoils, and is replaced by irregular, turbulent airflow. In these situations the ability of the airfoil to produce the required force to sustain regular flight gets compromised to various degrees. Stall, specifically deep-stall on the wings of airplanes, is one of the main causes of major aviation accidents. At present the prevention of stall is the duty of the flight crew and/or automated systems, which monitor flight parameters and ensure the avoidance of dangerous situations leading to stall, which, in case of the so-called deep stall, primarily comprise too high angles of attack and/or too low airspeed. However, these are secondary devices, which require first the recognition of the hazard on the part of the crew or pertinent systems, followed by decision and corrective action, each step carrying the potential for error, therefore it may be desirable to provide the airplane with a built-in, shaped aerodynamic means to prevent such deep stall, which works independently from crew or systems, and in cases when the limits of the regular flight envelope are exceeded in a process that can lead to deep-stall, it changes the aerodynamics of the airfoils in a manner as to restore regular flight.

### BRIEF SUMMARY OF THE INVENTION

The invention is concerning general purpose aircraft of conventional layout, having a pair of large, load-bearing wings at approximately the middle of the aircraft fuselage, and an empennage comprising one vertical and two horizontal fins, all being generally smaller than the wing of the aircraft. The purpose of the invention is to yield an aerodynamic means based on the shaping of the leading edge of the wing and the tandem working of the wing and tail, which in cases of situations having the potential of deep stall change the aerodynamics of the airplane to prevent such stall, as an improvement over presently known devices.

The essence of the invention is a wing (1), (hereinafter: main wing), with a relatively sharp leading edge (3), the sharpness being in comparison with that on present general purpose aircraft, and a positive lift-producing horizontal stabilizer (2), (hereinafter: tail wing), with regularly rounded leading edge (4). Sharp leading edge is known to be prone to cause flow separation and stall at rising angles of attack, and this effect is used in the invention to actually cause an artificial stall on the main wing (1) of the airplane at the limit of the regular flight envelope, while the tail wing (2), being provided with the regular leading edge (4) and therefore stall-prone only at a later stage, continues to produce lift. As a result, the main wing (1) will lose lift due to the stall and sink, while the tail wing (2) holds the tail in level, and the airplane sets back to level flight.

To make it feasible it is imperative to blend a working longitudinal stability means in the invention, which works with a lift-producing tail. For this purpose the invention employs a set of swept-back wings in the place of main wing (1), which has a relatively flat lift-coefficient (CL) curve, and whose aerodynamic force acts immediately before the center of gravity of the airplane, and a tail wing (2) of a type with much steeper CL curve, such as a straight wing, whose aerodynamic force acts in the tail. In the invention it is not a prerequisite to use specifically straight wing in the tail, but since it seems the most suitable for the requirements in the invention, it is being explained hereinafter in association with such wing. As a result of this arrangement, in cases of un-commanded changes in angle of attack the change of lift (ΔL) is greater on the tail wing (2) than on the main wing (1) due to its steeper CL curve, and the resulting greater increase in lift-force on said tail wing (2) together with its greater moment arm is to provide the necessary stabilizing force to counter the disturbance, and force the airplane back to level flight.

In the invention the center of gravity of the airplane falls between the wing and the tail, thus the primary means to resist un-commanded movements around the lateral as is the mass of the airplane itself, which resists vertical forces acting on it and results a more stable flight, which is the opposite to present longitudinal stability arrangements, in which the weight of the airplane tries to destabilize the aircraft. Besides the stall-prevention the invention represents substantial other advantages. The all-lift layout excludes the drag-loss on the downward acting horizontal stabilizers in the presently used layouts, and the tail wing (2) area can be deducted from the main wing (1) area, since the tail carries part of the weight of the airplane, allowing a smaller main wing. Further substantial drag-reduction results from the sharp wing-leading edge (3) on the main wing. As a possibility offered by the invention (although not an actual part of it), differential leading-edge (3) sharpening can prevent the moving of the aerodynamic force toward the wing root in the swept-back main wing (1) by causing the full length of the wing to stall at the same time. The reason is, that swept-back wings stall at the tip first. Therefore, if the leading edge sharpness (3) is appropriately less at the tip within the limits of the sharpness required to make the invention work, thereby delaying the onset of the tip-stall, but appropriately greater at the root, causing it to stall at the same time with the tip, it will ensure that the whole main wing (1) stalls at the same time preventing the moving of the aerodynamic force to the wing root, thereby enhancing longitudinal stability.

The equipping of the tail (2) wing with moving surfaces, such as slats and flaps, can reduce the stall-speed of the airplane and allow slower TO and landing speeds, resulting shorter TO and landing distances. Swept-back wings are more speed-sensitive and have less drag, than straight wings. It is a further flight safety advantage in the invention, since in cases of unstable flight (spins, pitchings, dives) the greater drag on the tail represents a stabilizing braking force in the tail of the airplane.

The pairing of the swept-back main wing (1) and the straight tail wing (2) may appear contradictory, since swept-back wings were meant to be an improvement over straight wings in terms of maximum attainable flight speed, and this advantage will be lost with such pairing. However, the benefits may certainly well justify the invention, in which the swept-back main wing (1) is not being employed in order to attain the maximum possible flight-speed for the airplane, but in order to result the opposites along with the tail wing (2) in terms of lift-coefficient, as a function of angle-of-attack, to make the invention work. The possible slower speed may well be acceptable especially for short and medium haul airplanes, where the time-difference resulting from slower speeds may be less noticeable, especially with respect to present environmental concerns, where the need for reduced pollution, a result of reduced consumption, may outweigh pure performance in importance. Reduced speed itself is a substantial fuel saving factor, and along with the other drag-reducing features the invention represents drastic fuel reduction for airplanes.

It is mentioned herein, that since the main wing (1) of the airplane in the invention is moved forward in comparison with present airplanes of similar types (general purpose ones), it may make it impossible to employ landing gear folding into the wing in the usual manner. Instead, wing-pods may be used carrying the landing gear, placed sufficiently rearward on the main wing (1), which is not a part of the invention, only the possibility of its use is mentioned as a possible solution. Such pods smoothen the airflow over the wing and participate in boundary layer control.

### BRIEF DESCRIPTION OF THE DRAWINGS

FIG. 1. shows the lift-coefficient curves of the swept-back and straight wings, marking also the difference in the change in lift (ΔL) on the two wing types as a function of the change of the angle of attack. ΔL₁ denotes the change of lift on the swept-back main wing (1), ΔL₂ denotes the change of lift on the straight tail wing (2). Coefficient of lift is abbreviated to CL, and angle of attack to AOA. As shown in the illustration, in case of a change of angle of attack, ΔL₂ is greater than ΔL₁.

FIG. 2 shows the moment diagram of the wings of the airplane of the invention. L₁ denotes the lift on the main wing (1), L₂ denotes the lift on the tail wing (2), center of gravity abbreviated to CG. As shown in the illustration, L₁ has a very short moment arm around the CG, while L₂ has a great moment arm around the CG.

FIG. 3. shows the airplane of the invention in level flight with the leading edge disposition of the main wing (1) and the tail wing (2), wherein both the main wing (1) and tail wing (2) produce regular lift to sustain level flight, marked by the upward pointing arrows.

FIG. 4. shows the airplane at max angle-of-attack (limit of the regular flight envelope) in an assumed situation in which the wings (1,2) are still configured to level flight, at which point stall takes place on the main wing (1) doe to the sharp leading edge (3), which drops as a result marked by the downward pointing arrow, while the tail wing (2), which does not stall at this point due to its regular, rounded leading edge (4) holds the tail in level, marked by the upward pointing arrow.

### DETAILED DESCRIPTION OF THE INVENTION

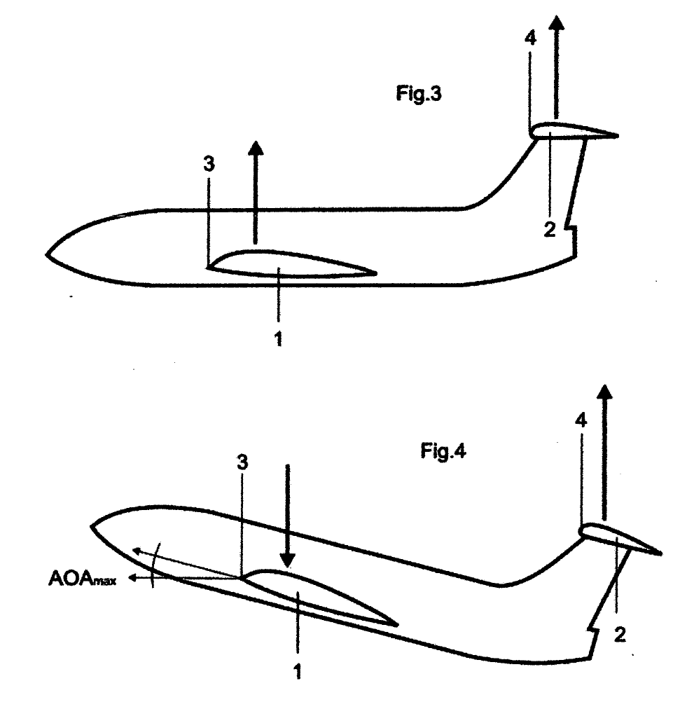

The airplane of the invention is equipped with a swept-back main wing 1, and a positive lift-producing straight tail wing 2 in place of the horizontal stabilizer, or alternatively a tail wing 2 possessing similarly steep lift-coefficient curve as straight wings. As shown in FIG. 3., swept-back wing 1 is provided with leading edge 3, which is sharper in comparison with that on present general purpose aircraft, the rate of sharpening being such as to cause flow separation and stall on main wing 1 at the point at which the maximum angle of attack of the regular flight envelope is exceeded. If the rate of sharpening 3 is appropriately less at the wingtip and more pronounced at the root within the limits of sharpness required to make the invention work, it will ensure that the wing stalls at the same time in full length, preventing the movement of the aerodynamic force of the wing to the wing-root in case of a stall. Tail wing 2 is provided with regularly rounded leading edge 4, also shown in FIG. 3., the rounding being in comparison with that on present general purpose aircraft. If the maximum angle of attack of the regular flight envelope is exceeded, leading edge 3 of the main wing 1, being sharp, causes flow separation and stall of main wing 1, while rounded leading edge 4 prevents stall on tail wing 2, which therefore continues to produce lift. As a result of the stall main wing 1 will lose lift and sink, while tail wing 2 holds the tail in level, as shown in FIG. 4., and the airplane will settle back to its original flight attitude.

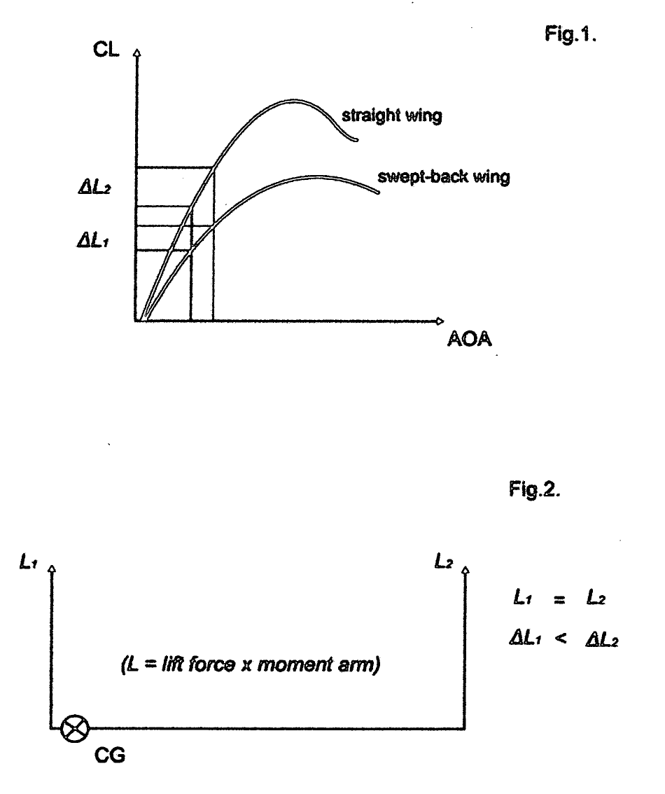

With respect to longitudinal stability, main wing 1 is a swept-back one, and tail wing 2 is a straight one or a type having a similarly steep lift-coefficient curve as straight wings, as described above. FIG. 1. shows the lift coefficient of such wings as a function of the angle of attack. As visible in FIG. 1., the change of lift is greater on straight wings for the same change in the angle of attack than that on swept-back wings, therefore in case of change of angle of attack ΔL₁<ΔL₂, where L₁ is the lift force by moment arm of main wing 1, and L₂ is the same of tail wing 2. If the airplane flies in level L₁ must be equal with L₂, as shown in FIG. 2. In cases of un-commanded pitching of the airplane the greater lift-change (ΔL₂) on tail wing 2 provides the stabilizing force acting against the pitching in order to restore the original attitude of the airplane. Therefore, in these situations the increased lift on tail wing 2 places the net aerodynamic force behind the center of gravity of the airplane, thereby satisfying longitudinal stability requirements stipulating that the net lift force must act aft of the center of gravity to ensure stable flight. Furthermore, since in the invention tail wing 2 produces positive lift, in case of un-commanded pitching up of the nose of the airplane tail wing 2 will sweep downward, which further increases its relative angle of attack and thus the lift (stabilizing force) of tail wing 2 during the movement, as opposed to present layouts generally used, where the horizontal stabilizer acts downward, and a downward movement, as a result of pitching, will decrease its stabilizing force during the movement. A similar effect takes place on main wing 1. The centre of gravity of the airplane can be conceived as a lateral axis around which the vertical movements take place, such as the pitching up of the nose. Since main wing 1 is a swept-back one, a part of it falls ahead of the center of gravity, and the other part falls behind it. Therefore, in case of an un-commanded pitching up of the nose of the airplane the part of main wing 1 ahead of the center of gravity will rise, reducing the relative angle of attack on this part of main wing 1 during the movement, while the part of main wing 1 falling behind the center of gravity will sweep downward, which will increase its relative angle of attack. As a result, there will be an increase of lift during the movement on the part of main wing 1 behind of the center of gravity, and a decrease of lift on its part ahead of it, which yields an additional stabilizing moment to force the nose of the airplane downward.

With respect to stability in cases of un-commanded positive or negative changes in airspeed, which also must be included in any working longitudinal stability means for general purpose airplane, the invention is suitable for such purpose if provided with the necessary means, which is not a part of the invention, only the possibility of such is mentioned herein. Accordingly, if min wing 1 is set at an angle of incidence greater than tail wing 2, in case of a sudden drop in airspeed the nose of the airplane will drop sooner, since swept-back wings are more speed-sensitive, and sooner start losing lift than straight wings. However, as a result of the movement of the nose down the angle of attack of tail wing 2 will reach 0 degree or even fall below (based on various factors unessential in this respect), providing 0 or even negative lift, and thereby preventing further drop of the nose of the airplane by letting (in case of 0 lift) or pushing (in case of negative lift) the tail down also, while main wing 1. still has a slightly positive angle of attack due to its greater angle of incidence. In this situation a slight nose-down equilibrium state will develop, and the airplane will enter a gliding pattern in which it picks up speed, leading to the reversal of the process and the restoration of the original attitude. In cases of sudden increase of airspeed, since all horizontal aerodynamic surfaces produce lift, there will be an increase in lift on main wing 1 and tail wing 2, which tries to hoist the airplane in an equilibrium state resulting from their respective angles of incidence, and the increase of drag, as a result of the increase of lift, will slow up the airplane.

1. Airplane with aerodynamic stall-prevention layout and pertinent longitudinal stability arrangement, comprising a general purpose-type airplane provided with a positive lift-producing, swept-back type wing whose aerodynamic force acts immediately before the center of gravity of said airplane, said wing provided with sharp leading edge to cause flow separation and stall on said wing when the limit of the regular flight envelope is exceeded with respect to the angle of attack of said airplane; said airplane also provided with a positive lift-producing horizontal stabilizer in the tail of said airplane, said horizontal stabilizer provided with rounded leading edge in order to delay the onset of stall on said horizontal stabilizer in comparison with said swept-back wing.

2. Airplane according to claim 1, wherein said horizontal stabilizer is of a type in which the rate of change in lift, as a result of the change of the angle of attack, is sufficiently greater in comparison with said swept-back wing to provide longitudinal stability means for said airplane.
